(19) United States
(12) Patent Application Publication
(10) Pub. No.: US 2018/0244547 A1
(43) Pub. Date: Aug. 30, 2018

(54) Method for Controlling an Electrochemical Water and Wastewater Treatment Process

(71) Applicant: Yanbo Li, Lanfang City (CN)

(72) Inventor: Yanbo Li, Lanfang City (CN)

(21) Appl. No.: 15/758,260

(22) PCT Filed: Sep. 14, 2016
(86) PCT No.: PCT/CN2016/099063

§ 371 Date: Mar. 7, 2018

(30) Foreign Application Priority Data
Sep. 14, 2015 (CN) 201510600655.7

(51) Int. Cl. C02F 1/467; C02F 1/461

(52) U.S. Cl. CPC C02F 1/4672; C02F 2103/06; C02F 1/46109

(57) ABSTRACT

Provided is a wastewater treatment process using an electrochemical electrode device. The electrochemical electrode device comprises at least one electrochemical electrode (30) comprising an appropriate electrode plate. The process comprises the following steps: causing water containing an undesired solute to pass through at least one electrochemical electrode (30); applying a direct current to the electrochemical electrode (30) to destroy the undesired solute in the water so as to output water having a lower concentration of the undesired solute. The direct current is adjusted via a specific power control procedure. The control procedure at least comprises the following cycle of an applied current sequence: a period of operation with a preset constant current flowing through an electrochemical electrode (30); applying a reverse constant current to reverse positive and negative electrodes while maintaining an absolute magnitude of the constant current; and a period of operation with the constant current flowing through the electrochemical electrode (30).

### TECHNICAL FIELD

This invention relates to a method for the treatment of contaminated feedwaters which achieves almost total destruction of undesirable solutes present in the water, such solutes may be organic or inorganic in nature, thereby producing a product water containing a low, or very low concentration of said solutes.

### BACKGROUND OF THE INVENTION

The presence of toxic organic chemicals in the environment is becoming a concern in particular with respect to the possible effect on human health. A particular category of water treatment process called advanced oxidation processes (AOP) have become influential in the removal of toxic organic, and toxic inorganic, contaminants from wastewater, treated drinking water, treated municipal sewage, and contaminated groundwaters. A subset of the available AOPs are the so-called electrochemical advanced oxidation processes (EAOP).

### SUMMARY OF THE INVENTION

The invention provides a means of controlling the way in which electrical power is supplied to an electrochemical cell used in an EAOP in order to improve the performance of the process and make it significantly more cost effective.

The benefit of this patent invention can be summarized as follows:

1) It is an advantage of my new process that on an overall cost of ownership basis, a process is provided which is cheaper to own and operate than other water treatment systems capable of removing or destroying the undesirable solutes

2) It is an advantage of the new process that it is reliably capable of producing treated water with very low concentrations of most if not all organic compounds dissolved in the feedwater stream

3) It is an advantage of the new process that it is reliably capable of producing treated water with very low concentrations of ammoniacal nitrogen

4) It is an advantage of the new process that it will produce treated water with very low levels of certain inorganic solutes such as sulfides and cyanides

5) It is an objective of the new process that the electrochemical cell is operated to ensure that there is an abundant population of hydroxyl radicals generated under all conditions

6) It is an objective of the new process that it not require “close control”, and accordingly it is easily able to cope with variability of the feedwater

7) It is an advantage of my novel process that it is extremely efficient and that the energy required is much lower than other electrochemical oxidation processes with comparable capability.

### BRIEF DESCRIPTION OF THE DRAWINGS

A fuller understanding of the invention can be gained from the following description when read in conjunction with the accompanying figures, where like reference numerals refer to identical or functionally similar elements throughout the separate views, which illustrate some, but not the only and exclusive, examples of embodiments of the invention and, as such, the figures disclosed herein are to be considered illustrative rather than limiting. In the drawings:

FIG. 1 illustrates a generalized process flow diagram for employing my novel water oxidation process in a variety of applications and with a variety of feedwaters;

FIG. 2 illustrates the profile of the power applied to the electrochemical cell utilized in my novel process; and

FIG. 3 illustrates a generalized flow diagram of an alternative way of employing my novel wastewater oxidation in a variety of applications and with a variety of feedwaters.

### DETAILED DESCRIPTION OF THE INVENTION

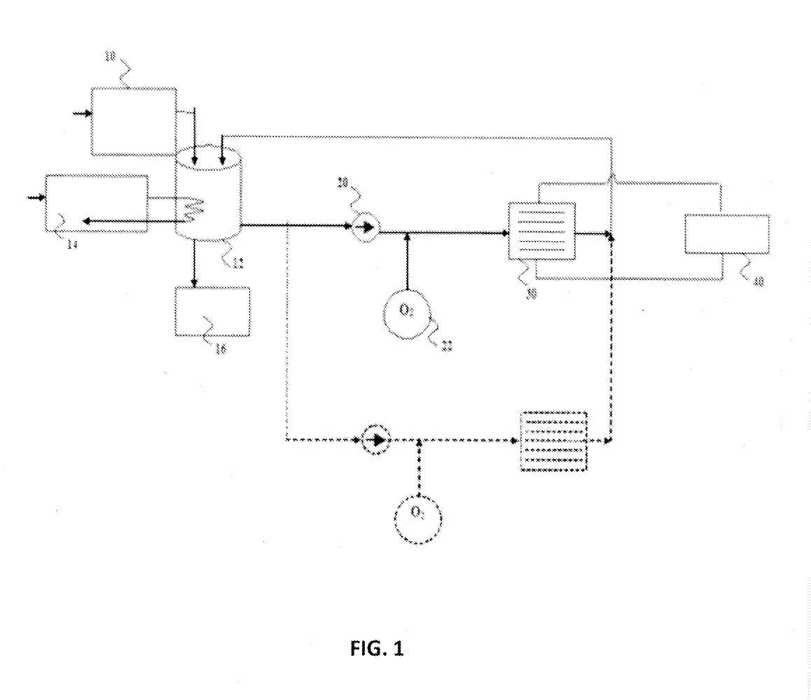

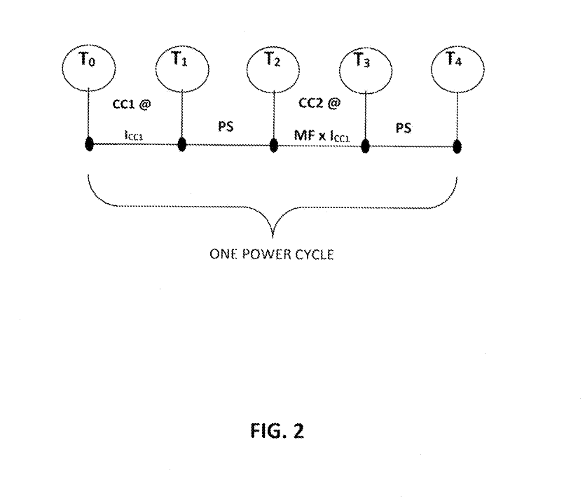

Referring now to FIG. 1, a generalized flow schematic illustrates one use of the water oxidation process of the invention. The feedwater 10 containing the undesirable solutes is provided to the storage tank 12. The feedwater is then routed to the inlet of a pump 20 and then to the inlet of an electrochemical cell 30. Before the water reaches the inlet of the electrochemical cell, oxygen gas 22 is injected in order to increase the concentration of dissolved oxygen in the water. The electrochemical cell 30 contains at least two electrodes manufactured from boron doped diamond (BDD), arranged such that the feedwater can flow between the electrodes and contact both electrodes. In an embodiment of the invention, the electrochemical cell may contain several pairs of BDD electrodes arranged to form parallel flow paths through the unit. A power supply 40 is connected to the electrochemical cell and an electric current controlled in accordance with the required power profile shown in FIG. 2 is caused to pass through the electrodes and the feedwater. After exiting the electrochemical cell the partially treated water is returned to the storage tank 12. The partially treated feedwater is then re-circulated through the electrochemical cell several times until the concentration of the undesirable solutes is reduced to a required value at which time the pump and electrochemical cell are de-energized and the contents of the storage tank sent to discharge 16. The rate at which the undesirable solutes are destroyed can be increased by adding more electrochemical cells to the system. The addition of a second electrochemical cell to the system is indicated by the dotted lines. As the water is continually circulated through the electrical cell the water is heated. Cooling water 14 is provided to a heat exchanger in the storage tank to remove the heat and maintain the temperature of the water at the required value. [WHAT IS THE REQUIRED VALUE?]

FIG. 2 is a schematic representation of the sequence of the power applied to the electrochemical cell in one embodiment of the invention. The applied power sequence is shown in FIG. 2, the essential features of the applied power sequence can be described as:

CC1: Between time T₀ and time T₁ a constant direct current 1 (CC1) is caused to flow through the electrochemical cell. The value of the current supplied to the cell, I_{CC1} can be determined by any one of a number of ways commonly known by one of ordinary skill in the art, or can be an informed estimate. [

Polarity Reversal (PS): following period CC1 at time T₁ the direction of the current flowing through the electrochemical cell is reversed.

CC2: Between time T₂ and time T₃ a constant direct current 2 (CC2) is caused to flow through the electrochemical cell. The value of the current supplied to the cell is equal to MF×I_{CC1} where MF is a modification factor calculated by comparing the measured potential difference across the cell during CC2 in the immediately previous power sequence cycle with specified required values. [NEED TO DEFINE WHAT ARE THE “SPECIFIED REQUIRED VALUES”]

Polarity Reversal: following period CC2 at time T₃ the direction of the current flowing through the electrochemical cell is reversed.

After the second current reversal period the applied power sequence is repeated. The applied power sequence is repeated for as many times as necessary in order to effect the required reduction of the undesirable solutes.

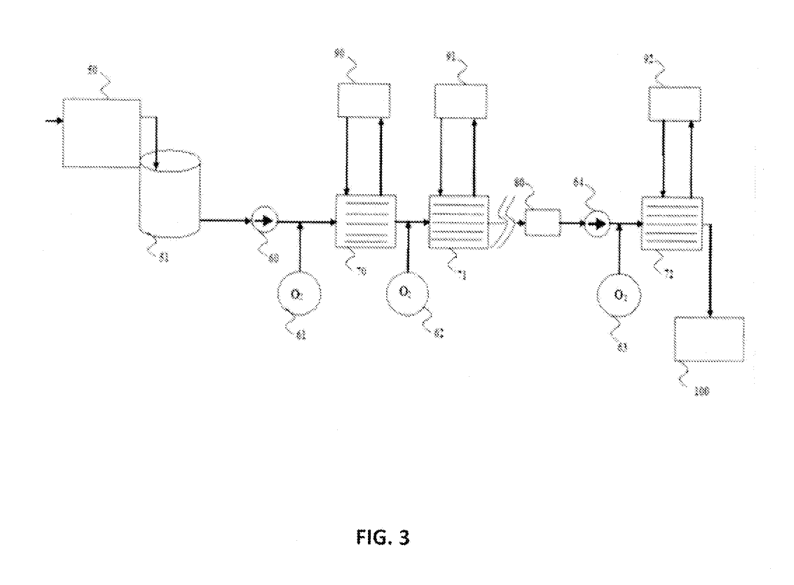

In FIG. 3 a generalized flow schematic illustrates an alternative use of the water oxidation process of the invention in industry. A feedwater 50 containing the undesirable solutes is sent to a feed tank 51. The feedwater is then forwarded by a pump, 60, to the inlet of an electrochemical cell 70. At the pump outlet oxygen gas 61 is injected into the water to cause the concentration of oxygen dissolved in the water to be increased. The electrochemical cell 70 contains at least two electrodes manufactured from boron doped diamond (BDD) arranged such that the feedwater can flow between the electrodes and contact both electrodes. In an embodiment of the invention, the electrochemical cell may contain several pairs of BDD electrodes arranged to form parallel flow paths through the unit. A power supply 90 is connected to the electrochemical cell and an electrical current controlled to the profile shown in FIG. 2 is caused to pass through the electrodes and the feedwater. After exiting the electrochemical cell the partially treated water is dosed with oxygen gas to ensure that the concentration of dissolved oxygen in the water is sufficient and is sent to the inlet of a second electrochemical cell 71. The second electrochemical cell 71 is similar to the first electrochemical cell 70 and is connected to a power supply 91 which is controlled in exactly the same manner as power supply 90. After exiting the second electrochemical cell the feedwater is subjected to treatment in subsequent similar electrochemical cells 72 until the concentration of the undesirable solutes is reduced to a value that allows the water to be discharged from the system 100. The subsequent electrochemical cells 72 are similar to the first electrochemical cell 70 and is connected to a power supply 92 which is controlled in exactly the same manner as power supply 90. Additional oxygen dosing 63 and pumps 64 are installed as required to maintain the concentration of dissolved oxygen and maintain the required flow through the system. As the feedwater passes through each electrochemical cell its temperature increases. At some point in the system a heat exchanger 80 is required to reduce the temperature.

It will be appreciated by those skilled in the art that changes could be made to the embodiments described above without departing from the broad inventive concept thereof. It is understood, therefore, that this invention is not limited to the particular embodiments disclosed, but it is intended to cover modifications that are within the spirit and scope of the invention, as defined by the appended claims.

What is claimed is:

1. A process for treatment of a feedwater stream in an electrochemical apparatus, said electrochemical apparatus comprising of at least one electrochemical cell containing suitable electrodes, to produce water with low concentrations of particular solutes, said process comprising:
(a) providing a feedwater stream which is a wastewater containing solutes therein, said solutes comprising organic species or molecules, ammoniacal nitrogen, organic nitrogen, inorganic sulfides, organic sulfides, and compounds containing an CN group;
(b) passing the feedwater from step (a) through said at least one electrochemical cell such that the water contacts the electrodes contained therein;
(c) causing a direct electrical current to flow through the at least one electrochemical cell so as to destroy the undesirable solutes thereby producing a product water stream with a lower concentration of the undesirable solutes. Said direct current to be varied and controlled to apply a specific power scheme to the electrochemical cell which includes at least one period of operation with a constant current flowing through the cell during which the potential difference across the cell is compared with previously specified values so as to calculate a factor which is used to modify the current caused to flow through the cell in a subsequent period of constant current operation.
(d) either returning the waste water passed through at least one of the electrochemical cells to the inlet of the electrochemical cell, forwarding the partially treated waste water to the inlet of a subsequent electrochemical cell to which power is applied in accordance with step c) above, so as to effect a continuing treatment of the water to successively destroy the undesirable solutes present in said water; or using both methods.

2. The process of claim 1, wherein at step (c), the direct electrical current to be varied and controlled to include at least one instance of the following applied power sequence:
i) A period of operation with a selected constant current flowing through the electrochemical cell, the value of the constant current can be selected by any method
followed by
ii) a further period of operation with a constant current flowing through the electrochemical cell, the value of the constant current can be any value between zero and that in step i)
followed by
iii) reversing the direction of the current passing through the electrochemical cell whilst maintaining the absolute magnitude of the current constant.
followed by
iv) a period of operation with a constant current flowing through the electrochemical cell during which the potential difference across the cell at particular points in the period of constant current operation is compared with certain required values. After such comparison calculate a modification factor to be applied to the constant current flowing through the cell in a similar step iv) of a subsequent cycle of the power sequence

3. The process of claim 1, wherein between step (a) and step (b) there is a preconditioning of the feedwater by any one of the following:
i) injecting an oxidant into the feedwater stream in order to increase the concentration of molecular oxygen dissolved in the feedwater;
ii) dosing a chemical into the feedwater stream in conjunction with the use of a catalyst in order to increase the concentration of molecular oxygen dissolved in the feedwater;
iii) Increasing the concentration of molecular oxygen dissolved in the feedwater by a combination of i) and ii);

4. The process of claim 1, wherein the electrochemical cell contains electrodes manufactured from boron doped diamond or contains electrodes on which the onset of oxygen evolution occurs at an anodic potential of greater than 2.0 volts versus SHE (Standard Hydrogen Electrode)

5. The process of claim 1, wherein the feedwater stream is the product from a water treatment plant supplying drinking water

6. The process of claim 1, wherein the feedwater stream is the product from a municipal wastewater treatment plant

7. The process of claim 1, wherein the feedwater stream is a contaminated groundwater
